(19) United States
(12) Patent Application Publication
(10) Pub. No.: US 2009/0014687 A1
(43) Pub. Date: Jan. 15, 2009

(54) LUMINESCENT, TRANSPARENT COMPOSITE MATERIALS

(75) Inventors: Stefan Kaskel, Dresden (DE); Ullrich Holle, Mulheim an der Ruhr (DE); Holger Althues, Dresden (DE)

Correspondence Address: NORRIS, MCLAUGHLIN & MARCUS, PA, 875 THIRD AVENUE, 18TH FLOOR, NEW YORK, NY, 10022, US

(73) Assignee: STUDIENG3SELLSCHAFT KOHLE MBH, MULHEIM AN DER RUHR (DE)

(21) Appl. No.: 10/595,468

(22) PCT Filed: Oct. 22, 2004
(86) PCT No.: PCT/DE04/02347

§ 371 Date: Apr. 21, 2006

(30) Foreign Application Priority Data
Oct. 22, 2003 (DE) 103-49-063.9

(51) Int. Cl. C09K 11/08; C09K 11/77; C09K 11/56; C09K 11/02

(52) U.S. Cl. 252/301.36; 252/301.4 R; 252/301.6 R; 252/301.4 P; 252/301.6 S; 252/301.6 F; 252/301.4 H; 252/301.5

(57) ABSTRACT

The invention relates to a transparent, luminescent plastic glass containing luminescent particles and to a method for producing the same. The glass hardly differs or differs only slightly in terms of transparency from pure plastic glass. In addition, said glass is easy to produce.

The present invention relates to a luminescent, transparent polymer, a method for producing this polymer and the use of the polymer for producing luminescent, transparent glasses and for producing glasses coated with the polymer.

Doped zinc sulfide nanoparticles can be produced by various methods in solution by precipitation reactions from zinc salts and a sulfur source, such as thiourea or sodium sulfide. For example, zinc acetate and manganese acetate are reacted with Na₂S in methanol, resulting in the formation of ZnS:Mn particles having a size of 3-4 nm. On excitation with WV light (300 nm), the ZnS nanoparticles doped with manganese luminesce with an orange color (590 nm) but only with low quantum yields of up to 4%.

For example, polymethacrylic acid in aqueous solution can be used as an auxiliary for stabilizing ZnS nanoparticles during the synthesis thereof. It is also known that the intensity of the photoluminescence of doped zinc sulfide nanoparticles can be considerably increased by the adsorption of acrylic acid or polyacrylic acid on the surface of the particles. Particles produced in this manner can be used, for example, for producing composite films.

Copper-doped ZnS nanocrystals are likewise suitable for producing polymer composites with poly(methyl methacrylate) (PMMA) in the form of thin films for the production of electroluminescent components. The incorporation, the dispersing, in the polymer is often effected mechanically.

CN1394900 describes a method for producing ZnS nanoparticles, a zinc salt in an organic solvent being reacted with H₂S and then being processed with the polymer to give a film. Whether the nano-ZnS/polymer dispersions are transparent or turbid is not described. JP2002105325 describes a transparent film of acrylic glass which contains semiconductor nanoparticles, such as ZnS and CdSe. The particles are stablilized by a phosphine oxide. Typically, these films contain a high proportion of solids and are at most a few microns thick in order to produce electroluminescent components therefrom.

JP2002047425 describes the production of thermoplastic composites from ZnS nanoparticles and a copolymer containing styrene-methacrylate for producing spectacle glasses having a high refractive index. Thiols are used for stabilizing the nanoparticles.

The methods disclosed in the prior art have the disadvantage that ZnS dispersions used have a colloidal stability insufficient for many applications. As a rule, stabilizers, such as thiols, phosphine oxides or surfactants, are added for improving the stability. Stabilizers, such as thiols, act as free radical scavengers in a free radical polymerization and have an adverse effect on the polymerization.

It was the object of the present invention to provide luminescent plastic glasses which differ scarcely or only slightly in particular in their transparency from the pure plastic glass. These glasses should preferably be capable of being produced in a simple manner.

The present invention accordingly relates to transparent, luminescent plastic glasses which contain luminescent nanoparticles.

In this case, transparent means that no opacity due to scattering effects is observable when the glass is viewed in visible light. For this purpose, it is firstly necessary to produce particularly small primary particles which lead to light scattering effects only to a small extent. Secondly, the particles produced as powder must be separated from one another by suitable dispersing methods in the monomer in order to eliminate scattering effects due to aggregates which are larger than the primary particle size, and this dispersion must not become turbid even in the course of the mass polymerization of relatively large amounts of monomers, which is used for shaping and producing glazing.

Plastic glass means that the plastic can assume any desired shape, for example the shape of a film or of a three-dimensional article.

The nanoparticles have a particle size of from 1 to 300 nm, preferably up to 100 nm, the individual discrete crystallites being meant here. Agglomerates whose total size is above 3 nm and in particular below 100 nm may also be present. The nanoparticles are preferably present in the form of discrete crystallites or small agglomerates which do not exceed a particle size of 50 nm. Larger agglomerates are disadvantageous since they may reduce the transparency of the final glass.

The glasses according to the invention are particularly suitable for producing decorative articles, as in luminescent glazing, decorative lamp parts or transparent color displays which use a UV source as the active light source. They can be used, for example, for illuminating printed placards, timetables, etc. In addition, the nanoparticles present according to the invention can be used for modifying the properties of the plastic glasses without reducing the transparency thereof. By introducing the nanoparticles, the refractive index can be increased, which is advantageous for using the glasses in optical components.

A further advantage is that many luminescent nanoparticles have a fire-retardant effect and can therefore contribute toward improving the fire protection when large-area glazing comprising plastic glazing, in particular glazing comprising poly(methyl methacrylates) is used.

The luminescent nanoparticles present according to the invention can be selected from luminescent materials (luminescent pigments) and/or luminescent materials doped with transition metals and/or lanthanides. Y₂O₃, YVO₄, Zn₂SiO₄, CaWO₄, MgSiO₃, BaF₂, SrAl₂O₄, ZnO, ZnS, Gd₂O₃S, La₂O₂S, BaFCl, LaOBr, Ca₁₀(PO₄)₆(F,Cl)₂, BaMg₂Al₆O₂₇, CeMgAl₁₁O₁₉, ZnSe, CdS and the like may be mentioned as suitable luminescent materials. Preferably used and very suitable luminescent materials are, for example, ZnS and ZnO. The luminescent materials are present in the glasses preferably in an amount of from 0.1 to 20% by weight, based on the amount of polymer.

For activating the luminescence, the nanoparticles can be doped with metals known for doping, such as with Al, transition metals, such as Cu, Ag or Mn, rare earth metals, such as Eu, Yb, etc. These metals are preferably present in an amount of from 0.1 to 5% by weight, based on the luminescent material.

The plastic glasses used according to the invention are preferably selected from customary transparent plastics. The plastic glasses are preferably polymers or polymer blends which are selected from polyacrylates and derivatives thereof, for example based on acrylic acid, butanediol monoacrylate, trimethylolpropane triacrylate, etc., polymethacrylates, polycarbonates, polystryenes, epoxides, polyethylene terephthalates, ethylene-norbornene copolymers and any desired copolymers of the corresponding monomers.

The present invention furthermore relates to a method for producing a luminescent, transparent plastic glass, which is characterized in that one or more luminescent nanoparticles are mixed with a polymer precursor or a solution of the polymer precursor, and the mixture obtained is polymerized in a manner known per se.

For carrying out the method, the luminescent nanoparticles are preferably thoroughly mixed with the polymer precursor or a solution of this polymer precursor in a first stage of the method, it being possible to obtain product having uniform luminescence and transparency if the nanoparticles are dispersed in the polymer precursor. In order to obtain a uniform dispersion, the mixture can be heated during the dispersing, but the temperature should be below the polymerization or decomposition temperature of the polymer precursor.

In a possible embodiment of the present invention, the nanoparticles are produced from their soluble salts by precipitation reactions known to the person skilled in the art, immediately before incorporation into the polymer precursor. It is also possible to form them in situ from the precursors as a mixture with the polymer precursor. Particularly stable dispersions are obtained if the production of the nanoparticles from the soluble salts is effected in an alcoholic solution, for example in the presence of methanol, ethanol, isopropanol, butanol or similar solvents. It is assumed that particles which can be particularly well stabilized by the polar radicals, such as the OH groups, and by polar groups in the polymer precursor form during the precipitation reaction. The particles of luminescent material which are obtained are distinguished by particularly good colloidal stability in the polymer precursor.

In a further possible embodiment of the present invention, the nanoparticles are first mixed with a portion of the polymer precursor. The mixture obtained or the dispersion can then be mixed with further polymer precursor, which may be one differing from the first portion, and then polymerized. If the nanoparticles used are those which, as described above, were obtained by the precipitation reaction from an alcoholic solution, they are preferably at least partly separated from the solvent and mixed or dispersed with a polymer precursor. The mixture obtained is preferably a clear dispersion in which the nanoparticles are dissolved or distributed in colloidal form. The mixture obtained or the dispersion is then mixed with further polymer precursor and, as described below, subjected to the polymerization.

The polymerization precursor is preferably selected from the monomers or polymerizable oligopolymers which are liquid at processing temperature or are soluble in a solvent. The nanoparticles can be mixed with the pure monomer or a mixture of a plurality of monomers or oligopolymers polymerizable with one another. If it facilitates the dispersing, the polymerization or the further processing, a solvent may also be added. The solvent should not adversely affect the polymerization and the stability of the nanoparticles in the polymer precursor or in the final product and should be easy to remove again. Suitable solvents are, for example, water, methanol, ethanol, tetrahydrofuran, CH₂Cl₂, low-boiling alkanes, such as pentane or hexane, aromatics, such as toluene, etc.

The nanoparticles are present in as finely distributed a form as possible, i.e. finely dispersed, in the prepared mixture. The particle size of the dispersed nanoparticles is preferably less than 100 nm.

The resulting mixture of nanoparticles and polymer precursor is polymerized in a manner known per se in the second stage of the method. As already described above, the nanoparticles are preferably mixed only with a portion of the polymer precursor required for producing the glass according to the invention. The remaining amount is added shortly before the polymerization. If it is advantageous for the polymerization, the mixture obtained and optionally further polymer precursors can be mixed with water for the preparation of a dispersion. Depending on the type of polymerization, an initiator and/or catalyst, etc. may also be added.

The mixture obtained in the second stage of the method is then subjected to the polymerization. Luminescent transparent glasses are obtained.

In a possible embodiment of the present invention, the mixture obtained in the second stage of the method is applied to a finished plastic or silicate glass and polymerized on this glass. In this way, glasses coated with luminescent transparent plastic glass can be obtained.

A further subject is the use of the luminescent transparent plastic glasses according to the invention for producing illuminating elements, luminescent displays, including inscriptions on objects, such as glasses, for the marking of plastics, etc.

A further subject is the use of the luminescent transparent plastic glasses according to the invention for producing coatings on inorganic or organic glasses.

### EXAMPLE

### Example 1

### A) Preparation of the ZnS:Mn/Acrylic Acid Dispersion

10 g of zinc acetate dihydrate and 0.2 g of manganese acetate tetrahydrate were dissolved in 300 ml of methanol. A solution of 3 g of sodium sulfide (61%) in 80 ml of a methanol-water (1:1) mixture was then added. The resulting dispersion was stirred for 15 min. The white zinc sulfide:manganese precipitate was separated off by centrifuging, taken up in 25 ml of acrylic acid and stirred at 100° C. for ½ h. The dispersion was then treated for 10 h at 90° C. The addition of 0.5 ml of water gave a transparent dispersion which, on excitation with UV light (366 nm), gave an intense, orange luminescence.

### B) Preparation of the ZnS:Mn/Acrylic Acid, Methyl Methacrylate Dispersion and Mass Polymerization Thereof

1 ml of the dispersion from A) was mixed with a mixture of 4 ml of methyl methacrylate, 2 ml of acrylic acid and 0.35 ml of water. 0.2% of the free radical initiator AIBN was added to the transparent dispersion and the latter was degassed and was sealed in a glass ampoule (d=10 mm) under a slight vacuum. The polymerization was effected at 50° C. in a water bath in the course of 6 hours. Curing was then effected for 3 h at 90° C.

### Example 2

### A) Preparation of the ZnS:Mn/Acrylic Acid Dispersion

5 g of zinc acetate dihydrate and 01 g of manganese acetate tetrahydrate were dissolved in 150 ml of methanol. A solution of 3 g of sodium sulfide (61%) in 80 ml of a methanol-water (1:1) mixture was then added. The resulting dispersion was stirred for 15 min. The white zinc sulfide:manganese precipitate was separated off by centrifuging, taken up in 30 ml of acrylic acid and stirred at 100° C. for ½ h. The dispersion was then treated for 18 h at 90° C. The addition of 0.5 ml of water gave a transparent dispersion which, on excitation with UV light (366 nm), gave an intense, orange luminescence.

### B) Preparation of the ZnS:Mn/Acrylic Acid, Methyl Methacrylate Dispersion and Mass Polymerization Thereof

0.5 g of zinc acetate was added to 1 ml of the dispersion from A) and the latter was then mixed with 2 ml of methyl methacrylate. 0.2% of the free radical initiator AIBN was added to the resulting stable and transparent dispersion and the latter was degassed and was sealed in a glass ampoule (d=10 mm) under a slight vacuum. The polymerization was effected at 50° C. in a water bath in the course of a few hours and was then completed at 90° C.

### Transparent ZnO/Plastic Composites

### Example 3

### a) Synthesis of the ZnO Nanoparticles

A stable ethanolic dispersion of the ZnO nanoparticles can be prepared as follows:

2.2 g (0.01 mol) of zinc acetate in 100 ml of ethanol are boiled and thus dissolved. The solution is cooled to room temperature and 37.5 ml of a 0.2 molar ethanolic NaOH solution (preparation by heating) are added at short time intervals and aging is effected for 24 h. The particles luminesce under UV radiation.

### b) Preparation of the Monomer Dispersion

10 ml of butanediol monoacrylate (BDMA) are added to 100 ml of this ethanolic dispersion. Ethanol can be distilled off from this mixture in vacuo so that about 10 ml of dispersion remain. After aging for a further 24 h, a white precipitate is separated off by centrifuging. The supernatant dispersion continues to show the green luminescence of the ZnO particles and is transparent; the precipitate contains no significant amounts of ZnO. The surrounding BDMA is polymerizable and miscible with other monomers (methyl methacrylate, styrene and trimethylolpropane triacrylate (TMPTA)). The copolymerization with these monomers leads to transparent, luminescent composite materials.

### c) Production of a ZnO-BDMA Composite Material

3 g of BDMA/ZnO dispersion are mixed with 1 g of TMPTA and 0.004 g of Lucirin TPO (UV initiator) and introduced between two glass sheets which are kept 1.5 mm apart by a flexible PVC ring. The mixture and the gas space above the liquid are flushed with argon and exposed for one minute to UV light (UVA cube, Hoenle). A small solid, transparent polymer sheet which has the fluorescence properties of ZnO is obtained.

### Example 4

### a) Production of a ZnO-BDMA/Styrene Composite Material

1.5 g of the BDMA/ZnO dispersion from Example 3 are mixed with 1.5 g of styrene, 1 g of TMPTA and 0.004 g of Lucirin TPO (UV initiator) and polymerized as in 3c) to give transparent sheets.

### Example 5

### Production of a ZnO-BDMA/Methyl Methacrylate Composite Material

1.5 g of the BDMA/ZnO dispersion from Example 3 are mixed with 1.5 g of methyl methacrylate, 1 g of TMPTA and 0.004 g of Lucirin TPO (UV initiator) and polymerized as in 3c) to give transparent sheets.

1. A transparent, luminescent plastic glass which contains luminescent nanoparticles.

2. The plastic glass as claimed in claim 1, characterized in that the nanoparticles are selected from luminescent materials (luminescent pigments) and/or luminescent materials doped with transition metals and/or lanthanides.

3. The plastic glass as claimed in claim 1 or 2, characterized in that the nanoparticles in the glasses are preferably present in an amount of from 0.1 to 20% by weight, based on the amount of polymer.

4. The plastic glass as claimed in either of claims 2 and 3, characterized in that the luminescent material is selected from Y₂O₃, YVO₄, Zn₂SiO₄, CaWO₄, MgSiO₃, BaF₂, SrAl₂O4, ZnO, ZnS, Gd₂O₃S, La₂O₂S, BaFCl, LaOBr, Ca₁₀(PO₄)₆(F,Cl)₂, BaMg₂Al₆O₂₇, CeMgAl₁₁O₁₉, ZnSe or CdS and any desired mixtures of the above.

5. The plastic glass as claimed in claim 4, characterized in that the luminescent material is selected from ZnS and ZnO.

6. The plastic glass as claimed in claim 4 or 5, characterized in that the luminescent material is doped with Al, transition metals, such as Cu, Ag or Mn, or rare earth metals, such as Eu or Yb.

7. The plastic glass as claimed in any of claims 1 to 6, characterized in that the plastic is a polymer or polymer blend selected from polyacrylates and derivatives thereof, polymethacrylates, polycarbonates, polystyrenes, epoxides, polyethylene terephthalates, ethylene-norbornene copolymers and any desired copolymers of the corresponding monomers.

8. A method for producing a transparent, luminescent plastic glass, characterized in that one or more luminescent materials are mixed with a polymer precursor or a solution of the polymer precursor in a first stage of the method and the mixture obtained is polymerized in a manner known per se in a second stage of the method.

9. The method as claimed in claim 8, characterized in that the luminescent materials are obtained by a precipitation reaction from an alcoholic solution.

10. The method as claimed in claim 8 or 9, characterized in that the luminescent materials are dispersed in the polymer precursor or a portion thereof or a solution of the polymer precursor or a portion thereof.

11. The method as claimed in any of claims 8 to 10, characterized in that the polymer precursor is selected from monomers or polymerizable oligopolymers which are liquid at processing temperature or are soluble in a solvent.

12. The method as claimed in any of claims 8 to 11, characterized in that the luminescent materials are present in the mixture with the polymer in a particle size of less than 100 nm.

13. The method as claimed in any of claims 8 to 12, characterized in that the plastic glass has the shape of a film or an article.

14. The use of the transparent, luminescent plastic glasses as claimed in any of claims 1 to 7 for producing illuminating elements, luminescent displays, including inscriptions on objects, such as glasses, for marking plastics, etc.

15. The use of the transparent, luminescent plastic glasses as claimed in any of claims 1 to 7 for producing coatings on inorganic or organic glasses.
